(19) United States
(12) Patent Application Publication
(10) Pub. No.: US 2006/0080974 A1
(43) Pub. Date: Apr. 20, 2006

(54) Drying apparatus, washing/drying apparatus, and operation methods of the apparatuses

(75) Inventors: Koji Ono, Gunma (JP); Kazuyoshi Tomochika, Gunma (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/249,431

(22) Filed: Oct. 14, 2005

(30) Foreign Application Priority Data
Oct. 20, 2004 (JP) JP 2004-141650
Oct. 20, 2004 (JP) 2004-305943

(51) Int. Cl. F25D 17/06; F25B 29/00; F26B 3/00

(52) U.S. Cl. 62/93; 165/63; 165/65; 34/468; 34/469

(57) ABSTRACT

An object is to provide an energy-saving drying apparatus which prevents liquid backflow, reduces time for a refrigeration cycle to be in a steady state, and can significantly reduce a time required for drying. The drying apparatus comprises: a drying chamber for accommodating a thing to be dried; a refrigerant circuit in which a compressor, a radiator, a decompression device and a heat sink are successively connected to one another in an annular form via a piping; an air circulation path in which air in the drying chamber exchanges heat with the radiator and the heat sink and circulates; and air circulation means provided in the air circulation path for circulating the air, wherein at least part of the piping from the decompression device to the compressor of the refrigerant circuit is provided within the air circulation path, and the air circulation path is equipped with heating means.

### BACKGROUND OF THE INVENTION

The present invention relates to a drying apparatus for drying a thing to be dried by use of a refrigeration cycle, and more particularly relates to a drying apparatus which prevents a refrigerant from being drawn into a compressor in a liquid state at the start of a drying operation and which can bring a steady state stably and in a short time.

A general drying apparatus has heretofore used an electric heater or a gas combustion heater as a heat source. After heating outside air by the heat source including the electric heater or the combustion heater to obtain high-temperature air, the air is blown into a drying chamber in which a thing to be dried is accommodated to dry the thing to be dried in the drying chamber. Moreover, the high-temperature air in the drying chamber, by which the thing to be dried has been dried, is exhausted to the outside. In such a drying apparatus, it requires a long time until the thing to be dried dries. Therefore, energy consumption for drying the thing to be dried increases, and there has been a problem that energy costs such as electricity and gas charges soar.

On the contrary, a drying apparatus in Japanese Patent Application Laid-Open No. 2004-141650 utilizes a refrigeration cycle in which carbon dioxide is used as a refrigerant. Air heated by a gas cooler is introduced into a drying chamber where a water content is evaporated from the thing to be dried. The water content is then condensed and removed from the air by an evaporator and the air is circulated, thereby making it possible to reduce a time required for drying without discharging the water content in a state of water vapor outside the drying chamber.

However, in the drying apparatus using the refrigeration cycle, a phenomenon called liquid backflow can occur at the start of operation wherein the refrigerant is drawn into the compressor in a liquid state. Hence, there has been a problem that the compressor is damaged or a life of the compressor is significantly reduced. Further, this drying apparatus has a problem that it takes some time for a refrigerant circuit to be in a steady state as compared with the drying apparatus using the heater as the heat source.

### SUMMARY OF THE INVENTION

Therefore, it is an object of the present invention to provide an energy-saving drying apparatus which prevents liquid backflow, reduces time for a refrigeration cycle to be in a steady state, and can significantly reduce a time required for drying.

The present invention has been made to achieve the foregoing object, and in a first invention, there is provided a drying apparatus comprising: a drying chamber for accommodating a thing to be dried; a refrigerant circuit in which a compressor, a radiator, a decompression device and a heat sink are successively connected to one another in an annular form via a piping; an air circulation path in which air in the drying chamber exchanges heat with the radiator and the heat sink and circulates; and air circulation means provided in the air circulation path for circulating the air, wherein at least part of the piping from the decompression device to the compressor of the refrigerant circuit is provided within the air circulation path, and the air circulation path is equipped with heating means.

Furthermore, in the drying apparatus of a second invention according to the first invention, a refrigerant sealed in the refrigerant circuit is in a liquid state or a gas-liquid mixed state when the compressor is stopped.

According to the drying apparatus in the first or second invention, a liquid backflow phenomenon can be prevented, and durability of the compressor can be improved. Further, time for a refrigeration cycle to be in a steady state can be reduced, and a drying time can be reduced.

In the drying apparatus of a third invention according to the first or second invention, the refrigerant circulating in the refrigerant circuit is carbon dioxide.

By using carbon dioxide for the refrigerant, much heat can be obtained in the radiator, and the drying time can be further reduced, in addition to effects by the first or second invention. Moreover, the refrigerant is environmentally friendly because it is a natural refrigerant, and it is extremely suitable as a refrigerant used in the drying apparatus because it is incombustible.

A washing/drying apparatus of a fourth invention comprises a drying apparatus according to one of the first to third inventions.

By utilizing the drying apparatus described above for presently prevailing washing/drying apparatuses, a time from washing to drying can be significantly reduced, in addition to effects by one of the first to third inventions.

In a fifth invention, there is provided an operation method for a drying apparatus which comprises: a drying chamber for accommodating a thing to be dried; a refrigerant circuit in which a compressor, a radiator, a decompression device and a heat sink are successively connected to one another in an annular form via a piping; an air circulation path in which air in the drying chamber exchanges heat with the radiator and the heat sink and circulates; and air circulation means provided in the air circulation path for circulating the air, wherein at least part of the piping from the decompression device to the compressor of the refrigerant circuit is provided within the air circulation path, and the air circulation path is equipped with heating means, and the method comprises refrigerant state estimation means for estimating a state of the refrigerant sealed in the refrigerant circuit, wherein the heating means is started before starting the compressor depending on the state of the refrigerant estimated by the refrigerant state estimation means.

According to the operation method for the drying apparatus in the fifth invention, a liquid backflow phenomenon can be prevented, and durability of the compressor can be improved. Further, time for a refrigeration cycle to be in a steady state can be reduced, and a drying time can be reduced.

In the operation method for the drying apparatus of a sixth invention according to the fifth invention, the refrigerant state estimation means comprises refrigerant temperature detection means for directly or indirectly detecting a temperature of the refrigerant, and the refrigerant state estimation means estimates the state of the refrigerant from the temperature of the refrigerant detected by the refrigerant temperature detection means.

According to the sixth invention, the present invention can be implemented at low cost because the state of the refrigerant can be estimated by the temperature which is a parameter relatively easy to detect, in addition to an effect by the fifth invention. Moreover, if this refrigerant temperature detection means also serves as a temperature sensor which is a safety device used when the drying chamber is opened/closed, a further cost reduction can be made.

In a seventh invention, there is provided an operation method for a washing/drying apparatus which comprises the steps of washing and drying and which uses a refrigeration cycle in the drying step, and the method comprises a preheat step which is carried out in parallel with a step immediately before the drying step to heat a refrigerant to a predetermined temperature or more.

Here, the washing step generally comprises processes such as washing, rinsing, spin-drying. According to the seventh invention, a liquid backflow phenomenon can be prevented, and durability of the compressor can be improved. Further, time for the refrigeration cycle to be in a steady state can be reduced, and a drying time can be reduced.

In the operation method for the washing/drying apparatus of an eighth invention according to the seventh invention, the preheat step comprises: a first preheat step of being supplied with heat from the outside of a refrigerant circuit to bring the refrigerant to the predetermined temperature or more; and a second preheat step of starting the refrigerant circuit to bring the refrigerant circuit into a steady state.

According to the eighth invention, time for a refrigeration cycle to be in a steady state can be significantly reduced, in addition to an effect by the seventh invention.

As described above, according to the present invention, the phenomenon of liquid backflow to the compressor can be prevented, and durability of the compressor can be improved. Moreover, the time for the refrigeration cycle to be in the steady state can be reduced, and the drying time can therefore be reduced, thereby making it possible to provide the energy-saving drying apparatus.

### BRIEF DESCRIPTION OF THE DRAWINGS

FIG. 1 is a schematic diagram representing a configuration of a drying apparatus of the present invention;

FIG. 2 is a P-h diagram when a refrigeration cycle of the present invention operates in a steady state;

FIG. 3 is a P-h diagram when the refrigeration cycle of the present invention is stopped;

FIG. 4 is a P-h diagram when warming is performed before the refrigeration cycle of the present invention is started;

FIG. 5 is a perspective view of the drying apparatus of the present invention;

FIG. 6 is a perspective view of the drying apparatus of the present invention from a viewpoint different from that of FIG. 5;

FIG. 7 is a perspective view of a drying unit in the drying apparatus of the present invention;

FIG. 8 is a flowchart of a washing operation in Embodiment 1 of the present invention;

FIG. 9 is a flowchart of a spin-drying operation in Embodiment 1 of the present invention;

FIG. 10 is a flowchart of a rinsing operation in Embodiment 1 of the present invention;

FIG. 11 is a flowchart of a spin-drying operation after the rinsing operation in Embodiment 1 of the present invention;

FIG. 12 is a flowchart of a preheat operation in Embodiment 1 of the present invention;

FIG. 13 is a flowchart of a drying operation in Embodiment 1 of the present invention;

FIG. 14 is an overall flowchart in a washing/drying apparatus in Embodiment 1 of the present invention;

FIG. 15 is an overall flowchart in a washing/drying apparatus in Embodiment 2 of the present invention;

FIG. 16 is a flowchart of a spin-drying operation after a rinsing operation in Embodiment 2 of the present invention;

FIG. 17 is a control flow diagram representing control during a preheat operation in Embodiment 2 of the present invention in a time-series form;

FIG. 18 is a flowchart of the preheat operation in Embodiment 2 of the present invention; and

FIG. 19 is a flowchart of a drying operation in Embodiment 2 of the present invention.

### DETAILED DESCRIPTION OF THE PREFERRED EMBODIMENT

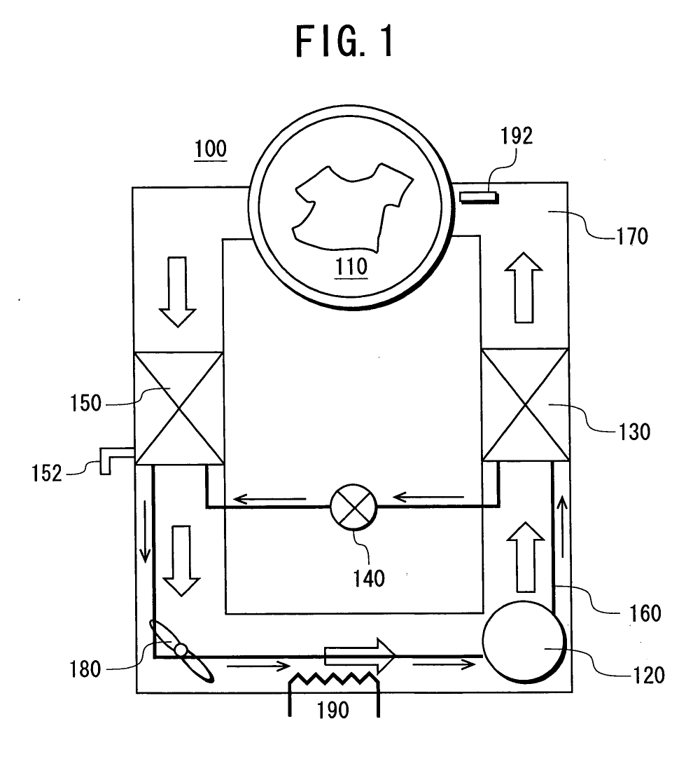

A configuration of a drying apparatus 100 according to the present invention will be described in detail using FIG. 1.

FIG. 1 is a schematic diagram representing a configuration of the drying apparatus 100 according to the present embodiment. The drying apparatus 100 comprises a drying chamber 110 for accommodating a thing to be dried; an internal intermediate pressure two-stage compression type compressor 120 which serves as a compression unit; a gas cooler 130 as a radiator; an expansion valve 140 as a decompression device; an evaporator 150 as a heat sink; a refrigerant circuit 160 in which the compressor 120, the gas cooler 130, the expansion valve 140 and the evaporator 150 are connected to one another in an annular form and which uses carbon dioxide as a refrigerant; an air circulation path 170 in which air in the drying chamber 110 circulates; a turbo fan 180 as air circulation means for circulating the air; and an electric heater 190 as heating means for heating the refrigerant at the start of a refrigeration cycle while heating the air circulating in the air circulation path 170.

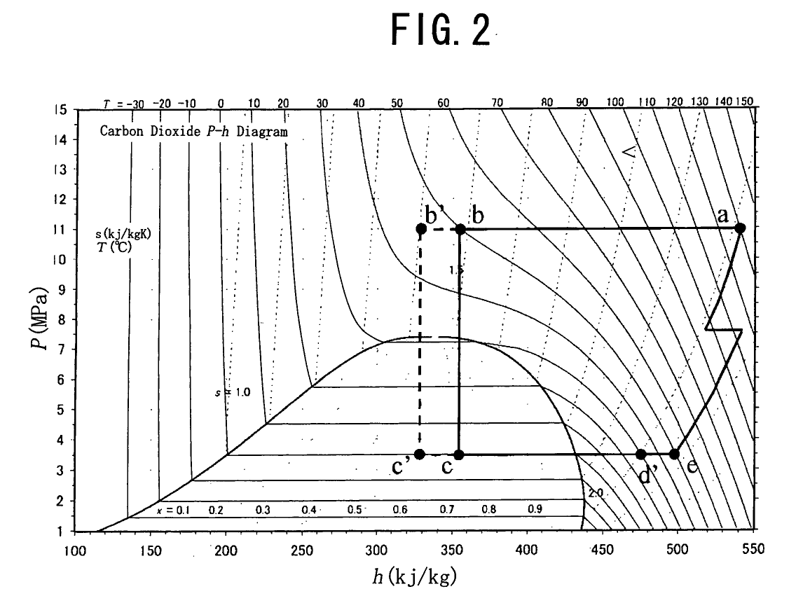

The refrigerant discharged from the compressor 120 is located at a point a in a graph shown in FIG. 2 if it is in a steady state. When the refrigerant is carbon dioxide, it is fed to the gas cooler 130 under a discharge pressure of about 10 to 12 Mpa and at a discharge temperature of about 100 to 130° C. (11 Mpa and 130° C. in the present embodiment). Further, the refrigerant is cooled to about 40 to 60° C. (a point b is at 50° C. in the present embodiment) by the air in the gas cooler 130, and fed to the expansion valve 140. On the other hand, the air passed through the gas cooler 130 is heated to about 80 to 100° C., and used to dry the thing to be dried in the drying chamber 110 (FIG. 1). A temperature of the heated air is monitored by a temperature sensor 192 as a safety device, and the air heated to about 80 to 100° C. enters the drying chamber 110, removes a water content from the thing to be dried, and discharged from the drying chamber 110 at a temperature of about 60 to 80° C. and a humidity of about 40 to 70% (an amount of water vapor retained in the air is about 52 to 205 g/m³ in terms of air pressure).

The refrigerant decompressed by the expansion valve 140 is fed to the evaporator 150 at about 3 to 4 Mpa (a point c is at 3.5 Mpa in the present embodiment), removes heat from the air discharged from the drying chamber 110 (point d), and returns to the compressor 120 (point e point d). At this time, if an intermediate heat exchanger (not shown) is disposed for heat exchange between the refrigerant coming out of the evaporator 150 and the refrigerant at a stage before the expansion valve 140, the point b in FIG. 2 moves to a position of a point b′, so that a more efficient refrigeration cycle can be achieved. On the other hand, since the air from which heat is removed by the evaporator 150 to be at about 20 to 40° C. has a saturated water vapor amount of, for example, about 30 g/m³ at 30° C., it cannot retain the water content (about 32 to 175 g/m³) exceeding the saturated water vapor amount as water vapor, and the water content therein is condensed and removed by the evaporator 150. The water is discharged from a drain 152 to the outside of the drying apparatus 100.

The air dehumidified by the evaporator 150 is again fed to the gas cooler 130 by the turbo fan 180. In the present invention, the compressor 120 is also disposed in the air circulation path 170 in which the dehumidified air circulates, so that the air before entering the gas cooler 130 is preheated and the compressor 120 can be air-cooled. Thus, waste heat of the compressor 120 can also be utilized to heat the air, and the compressor 120 can be prevented from being at abnormally high temperature, thereby enabling the energy-saving drying apparatus which can improve durability of the compressor 120 and reduce a drying time.

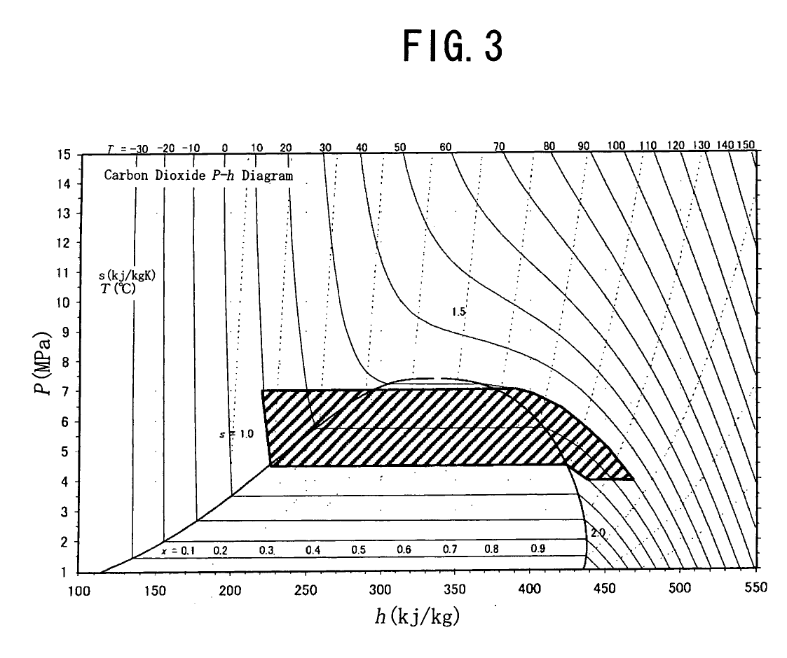

When the refrigeration cycle is operating in the steady state, both the refrigerant and air circulate as described above. However, when the refrigeration cycle is stopped, the refrigerant is retained in the refrigerant circuit 160 under an equilibrium pressure of about 4 to 7 Mpa and at a temperature of about 10 to 30° C. indicated by hatching in FIG. 3. Under such a condition, in a case of carbon dioxide, it is retained in the refrigerant circuit 160 in a gas-liquid mixed state. Therefore, at the start of the refrigeration cycle, a so-called liquid backflow phenomenon occurs wherein the refrigerant is drawn into the compressor 120 in a liquid state, which might damage the compressor 120. Therefore, in the present invention, the electric heater 190 is disposed in the vicinity of the refrigerant circuit 160 between the evaporator 150 and the compressor 120 within the air circulation path 170.

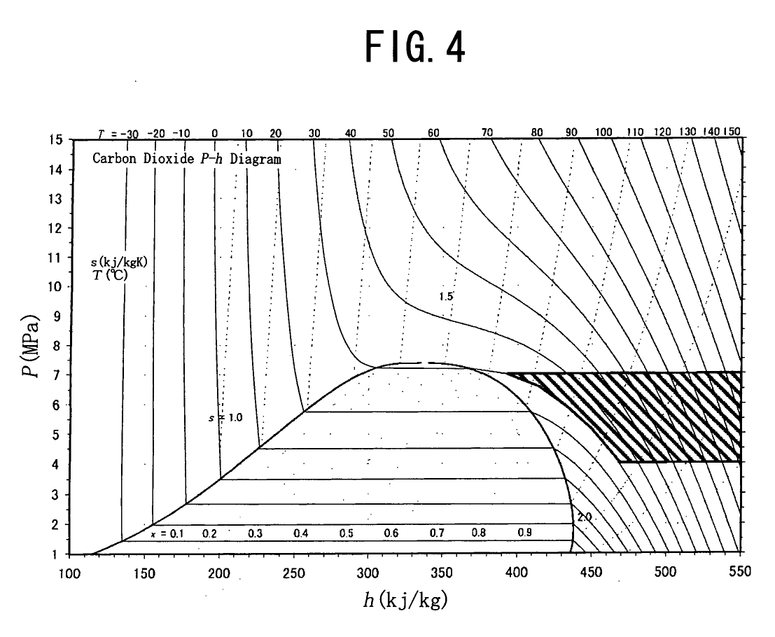

Before starting the refrigeration cycle, the turbo fan 180 and the electric heater 190 are started to warm the air within the air circulation path 170. In the present invention, since most of the piping of the refrigerant circuit 160 is disposed to pass through the air circulation path 170, the thing to be dried is pre-dried and, at the same time, the refrigerant in the refrigerant circuit 160 is also warmed by warming the air by the electric heater 190. When the refrigerant is carbon dioxide, it becomes a gas as long as the temperature is about 30° C. or more even if the pressure is about 4 to 7 Mpa as indicated by hatching in FIG. 4, and therefore, possibility of occurrence of the liquid backflow phenomenon can be avoided. Especially, in order to prevent the phenomenon of liquid backflow to the compressor 120, it is effective to dispose the electric heater 190 in the vicinity of the refrigerant circuit 160 between the evaporator 150 and the compressor 120 within the air circulation path 170.

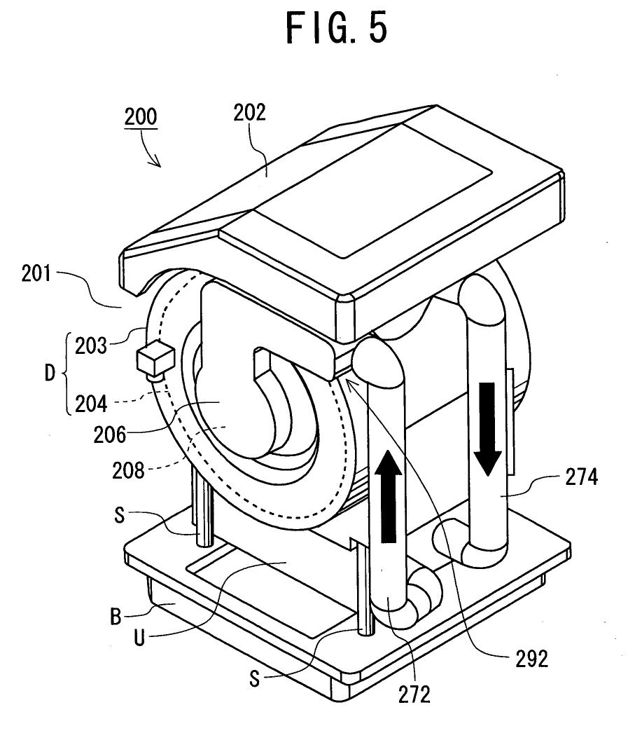

Furthermore, when the temperature of the refrigerant has become 30° C. or more, the electric heater 190 is stopped, and the refrigeration cycle is started. Alternatively, when an outside air temperature exceeds 30° C., for example, in the middle of summer, it is considered that the refrigerant also exceeds 30° C., and therefore, the refrigeration cycle may be started without starting the electric heater 190. A specific structure to realize the configuration of the drying apparatus 100 as described above will be described using FIGS. 5 to 7.

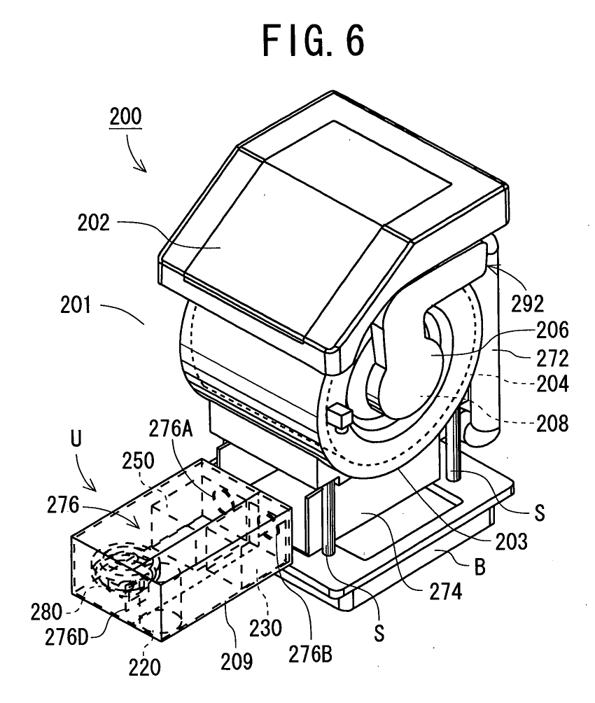

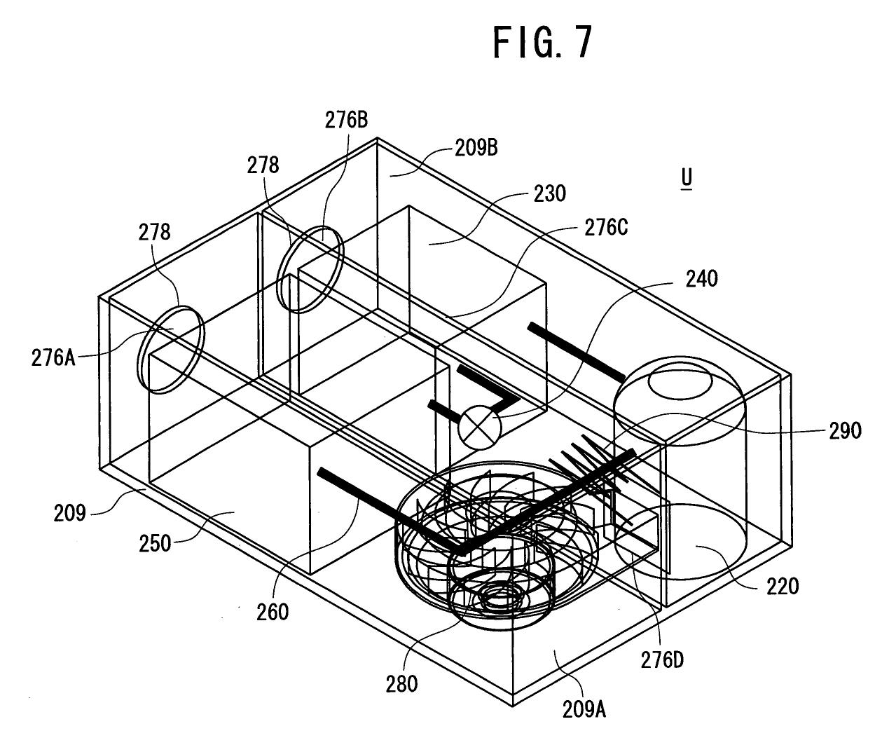

FIGS. 5 and 6 show internal configuration diagrams of a washing/drying apparatus 200 which carries out a washing operation and a drying operation after termination of the washing operation as a drying apparatus to which the present invention is applied. FIG. 7 shows an internal configuration diagram of the washing/drying apparatus 200 from which a part corresponding to a drying unit U is extracted.

This washing/drying apparatus 200 is used for washing and drying a thing to be washed such as clothes (the thing to be washed turns to the thing to be dried in the drying operation). An opening/closing door 202 for taking in/out the thing to be washed is attached to a middle portion of an upper surface of a main body 201 (FIGS. 5 and 6 show the inside of a case of the main body 201) forming an outer structure, and an operation panel (not shown) in which various operation switches and a display portion are disposed is provided on the upper surface of the main body 201 positioned beside the opening/closing door 202.

In the main body 201, there is provided a drum main body D constituted of a cylindrical resin outer drum 203 disposed symmetrically with respect to a cylindrical shaft and capable of storing water, and a cylindrical stainless steel inner drum 204 disposed inside the outer drum 203 and serving both as a washing tank and a spin-drying tank. The inner drum 204 is coupled to a shaft of a driving motor (not shown) attached to a side wall (an inner side of FIG. 5) of the outer drum 203, and the inner drum 204 is held rotatably in the outer drum 203 on a rotation axis which is an axis of the inner drum 204 coupled to the shaft of the driving motor. The inside of the inner drum 204 serves as a drying chamber 210 for accommodating the thing to be washed.

A watertight outer opening/closing lid (not shown) for taking in/out the thing to be washed is provided in an upper part of the outer drum 203 so as to correspond to the opening/closing door 202. A large number of through-holes (not shown) via which air and water can circulate are formed in a whole peripheral wall of the inner drum 204. A stopping position of the inner drum 204 is defined, and an inner opening/closing lid (not shown) for taking in/out the thing to be washed is disposed in a position (upper surface) of the inner drum 204 which corresponds to the outer opening/closing lid of the outer drum 203 when the inner drum 204 is stopped.

The above-mentioned driving motor is a motor for rotating the inner drum 204 on a shaft in the right/left direction in the washing operation and the drying operation after termination of the washing operation. The driving motor is attached onto an inner side of FIG. 5, and is controlled in such a manner as to rotate the inner drum 204 during the drying operation at a speed lower that that during the washing operation. A hollow portion 206 having a hollow inner portion is formed at one end of the shaft of the driving motor on a front side of FIG. 5, and an air circulation path 270 described later is connected to the inner drum 204 via an unshown air inflow port 208 of the hollow portion 206.

In an upper part of the main body 201, a water supply passage (not shown) which is water supply means for supplying water into the inner drum 204 is disposed, and one end of the water supply passage is connected to a water source such as a water system via a water supply valve. The opening/closing of the water supply valve is controlled by a control device. The other end of the water supply passage is connected to the outer drum 203 to communicate with the inside thereof. When the water supply valve is opened by the control device, the water (tap water) is supplied from the water source into the inner drum 204 (drying chamber 210). Moreover, a draining passage (not shown) which is draining means for discharging the water in the inner drum 204 (drying chamber 210) is provided in a lower part of the main body 201, and one end of the draining passage communicates with a bottommost portion of the outer drum 203 via a draining valve which is controlled to open/close by the control device. The other end of the draining passage leads to the outside of the washing/drying apparatus 200, and extends to a drain ditch or the like.

The above-mentioned air circulation path 270 is constituted in the main body 201 from a rear side to a lateral side of the outer drum 203. The air circulation path 270 sends the air which has exchanged heat with a gas cooler 230 as a radiator into the inner drum 204 (drying chamber 210) by a turbo fan 280 as air circulation means, and causes the air passed through the inner drum 204 (drying chamber 210) to exchange heat with an evaporator 250 as a heat sink. The air circulation path 270 comprises an inflow side duct member 272, an outflow side duct member 274, an air passage 276 formed in the drying unit U described later, etc.

One end of the inflow side duct member 272 is connected/fixed to the outer drum 203 in such a manner as to communicate with the inside of the inner drum 204 (drying chamber 210) via the air inflow port 208 of the hollow portion 206, and the other end thereof is connected/fixed to an outlet 276B of the air passage 276 formed in the drying unit U. One end of the outflow side duct member 274 is connected/fixed to the outer drum 203 in such a manner as to communicate with the inside of the inner drum 204 (drying chamber 210), and the other end thereof is connected/fixed to an inlet 276A of the air passage 276. It is to be noted that both the duct members 272, 274 are made of a metal or a heat-resistant synthetic resin. Moreover, the other ends of the duct members 272, 274 (sides connected to the outlet 276B and the inlet 276A of the air passage) are shaped to slightly taper off toward their tips.

As shown in FIG. 7, the drying unit U comprises a refrigerant circuit 260 in which a compressor 220, the gas cooler 230, an expansion valve 240 as a decompression device, and the evaporator 250 are successively connected to one another in an annular form via a piping; the above-mentioned turbo fan 280; and an electric heater 290. Further, in the drying unit U of the washing/drying apparatus 200, the refrigerant circuit 260, the turbo fan 280 and the electric heater 290 are integrally constructed, and these are contained in a case 209 covering parts except for a motor portion of the turbo fan 280 with a heat insulating member so as to be formed as a cassette. This cassette is then placed in a predetermined range under a center of gravity of the drum main body D at its bottom. The inlet 276A and the outlet 276B of the air passage 276 are formed in one side surface of the case 209. The inlet 276A and the outlet 276B are cylindrical holes, and seal members 278 such as rubber are attached all around circumferences of these holes. In the present embodiment, one cylindrical hole is provided for each of the inlet 276A and the outlet 276B, but a plurality of holes may be provided without limiting to one hole. In a case of one hole, positioning is easy when the drying unit U is set in the main body 201. In a case of a plurality of holes, air resistance in this portion can be reduced. Further, the drying unit U is also electrically connected to the main body 201 by an unshown wiring socket, and operation control and power supply for the compressor 220, the expansion valve 240, the turbo fan 280 and the electric heater 290 in the drying unit U are performed from the main body 201 via the wiring socket.

The inside of the case 209 is separated by a heat insulating partition member 276C, and the inlet 276A of the air passage 276 is located in one part of the case 209 separated by the partition member 276C, while the outlet 276B of the air passage 276 is located in the other part thereof. In FIG. 7, on a front side of the partition member 276C within the case 209, a communication hole 276D is formed for communication between the insides of the one case (a case 209A on the evaporator 250 side) and the other case (a case 209B on the gas cooler 230 side) that are separated by the partition member 276C. Thus, in the case 209, there is constructed the air passage 276 in which the air flowing from the inlet 276A into the evaporator side case 209A moves into the gas cooler side case 209B through the communication hole 276D and flows out from the outlet 276B.

Furthermore, the evaporator 250 is placed on a rear side of the evaporator side case 209A separated by the partition member 276C, and the turbo fan 280 is placed on a front side thereof. During the drying operation, the turbo fan 280 is configured to send drying air heated by exchanging heat with the gas cooler 230 provided in the gas cooler side case 209B into the inner drum 204 (drying chamber 210), and circulate the drying air in the inner drum 204 (drying chamber 210), and then return it to the evaporator 250. Moreover, the turbo fan 280 is provided adjacently to the communication hole 276D, and disposed to have a suction port on the evaporator 250 side and a discharge port on the communication hole 276D side. Gaps in the discharge port of the turbo fan 280 and the communication hole 276D are closed to ensure that the air in the air passage 276 flows from the evaporator side case 209A to the gas cooler side case 209B via the turbo fan 280.

The gas cooler 230 is placed on a rear side of the gas cooler side case 209B separated by the partition member 276C, and the compressor 220 is placed on a front side thereof. The compressor 220 is provided in the air passage 276 adjacent to the communication hole 276D. That is, the compressor 220 is disposed so that the air discharged from the turbo fan 280 passes through the compressor 220 via the communication hole 276D. In such a configuration, by the operation of the turbo fan 280, the air which has circulated in the inner drum 204 (drying chamber 210) and dried the thing to be washed flows into the air passage 276 within the evaporator side case 209A separated by the partition member 276C from the inlet 276A via the outflow side duct member 274 of the air circulation path 270. Further, the air is cooled by exchanging heat with the evaporator 250 and dehumidified. Then, the air is blown into the turbo fan 280 provided in the air passage 276 on the front side, and thus flows into the gas cooler side case 209B from the communication hole 276D. Moreover, the air passes around the compressor 220, and is heated by exchanging heat with the gas cooler 230 provided in the air passage 276 on the outlet 276B side, and then flows out from the outlet 276B to flow into the inner drum 204 (drying chamber 210) via the inflow side duct member 272.

Here, since the drum main body D causes vibration/displacement by rotation of the inner drum 204, the drum main body D is fixed onto a base B positioned on a bottom surface of the main body 201 via a suspension S having a vibration absorbing function in order to reduce vibrations/noises. That is, the rotary inner drum 204 is attached onto the base B via the outer drum 203 and the suspension S. A predetermined amount of carbon dioxide is sealed as a refrigerant in the refrigerant circuit 260, and the refrigerant circuit 260 has a supercritical pressure on a high pressure side. It is to be noted that the unshown control device controls operating of the driving motor, opening/closing of the water supply valve of the water supply passage, opening/closing of the draining valve of the draining passage, operating of the compressor 220, throttle adjusting of the expansion valve 240, and an air amount of the turbo fan 280. Further, the control device also controls the temperature of the drying air passed through the gas cooler 230 in order to prevent the thing to be washed accommodated in the inner drum 204 from being discolored or damaged.

### Embodiment 1

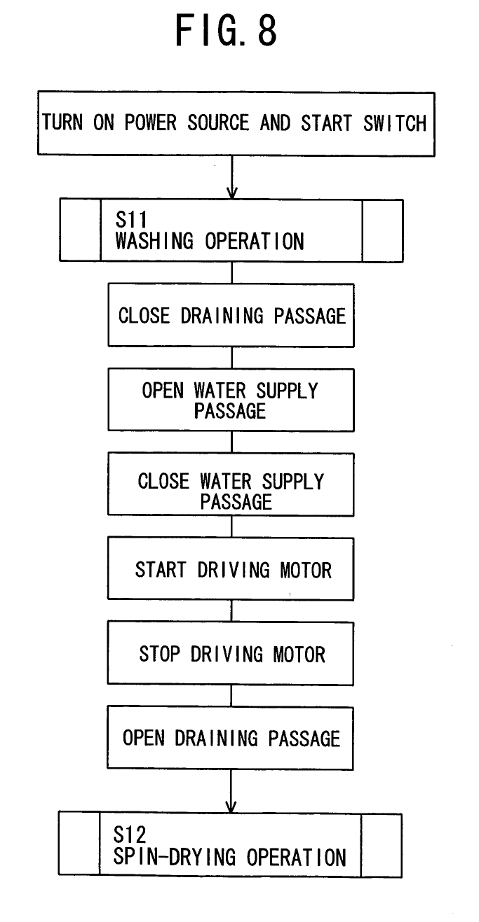

Next, an operation in Embodiment 1 of a washing/drying apparatus 200 will be described with FIGS. 8 to 14.

As shown in FIG. 8, a thing to be washed and a predetermined amount of washing powder corresponding to an amount of the thing to be washed are thrown into an inner drum 204 (drying chamber 210). When a power switch and a start switch are operated among the above-described operation switches, a control device starts a washing operation (S11). Moreover, the control device opens a water supply valve of an unshown water supply passage to open the water supply passage. Accordingly, water is supplied into the inner drum 204 (drying chamber 210) from the water source. It is to be noted that, at this time, a draining valve of the draining passage is closed by the control device. When a predetermined amount of water is stored in the inner drum 204 (drying chamber 210), the control device closes the water supply valve to close the water supply passage. Accordingly, water supply from the water source is stopped.

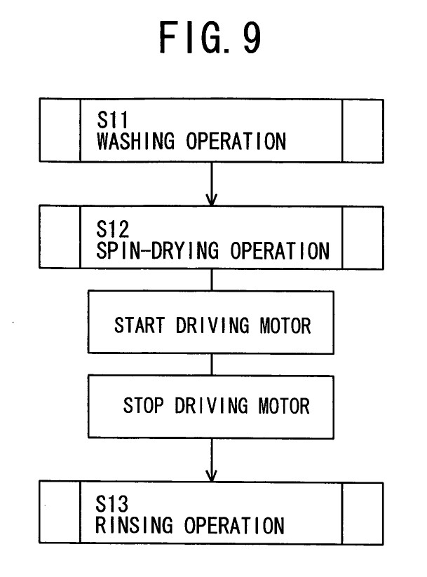

Next, a driving motor formed in a side surface of a main body 201 is energized/started by the control device to rotate a shaft, and the inner drum 204 attached to the shaft starts rotating in an outer drum 203, thereby starting a washing operation (S11). When a predetermined time elapses from the start of the washing operation (S11), the driving motor is stopped by the control device, and the draining valve of the draining passage is opened to discharge the water (washing water) in the inner drum 204 (i.e., the outer drum 203). Moreover, as shown in FIG. 9, when the water in the inner drum 204 (drying chamber 210) is discharged, the control device again operates the driving motor to spin-dry the thing to be washed. After performing the spin-drying operation (S12) for a predetermined time, the control device closes the draining valve of the draining passage.

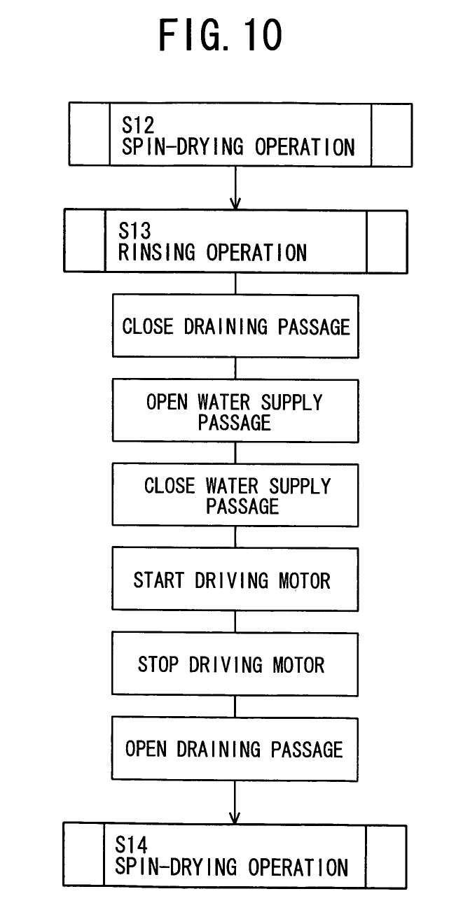

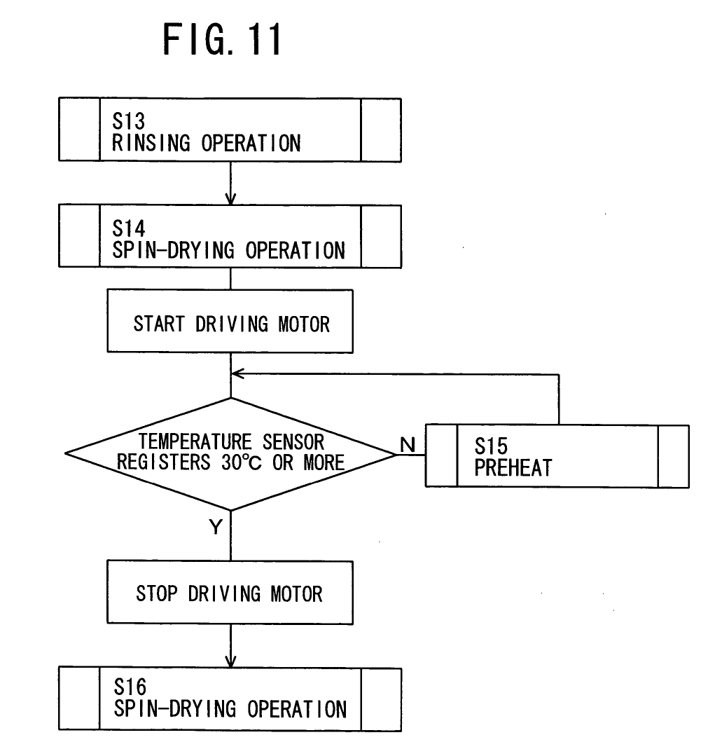

Next, as shown in FIG. 10, the control device shifts to a rinsing operation (S13), and opens the water supply valve of the water supply passage to open the water supply passage. Accordingly, the water is again supplied into inner drum 204 (drying chamber 210) from the water source. When a predetermined amount of water is supplied into the inner drum 204 (drying chamber 210), the control device closes the water supply valve to close the water supply passage. Accordingly, the water supply from the water source is stopped. Moreover, after a rotation operation of the driving motor is repeated for a predetermined time to perform the rinsing, the control device stops the driving motor, and opens the draining valve of the draining passage to discharge the rinsing water in inner drum 204 (drying chamber 210) to the draining passage. When the rinsing water in the inner drum 204 (drying chamber 210) is discharged, the control device again operates the driving motor, rotates the inner drum 204 in the same manner as described above, and shifts to a spin-drying operation (S14) to spin-dry the thing to be washed, as shown in FIG. 11.

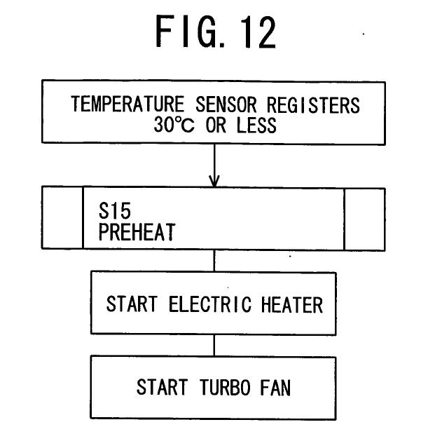

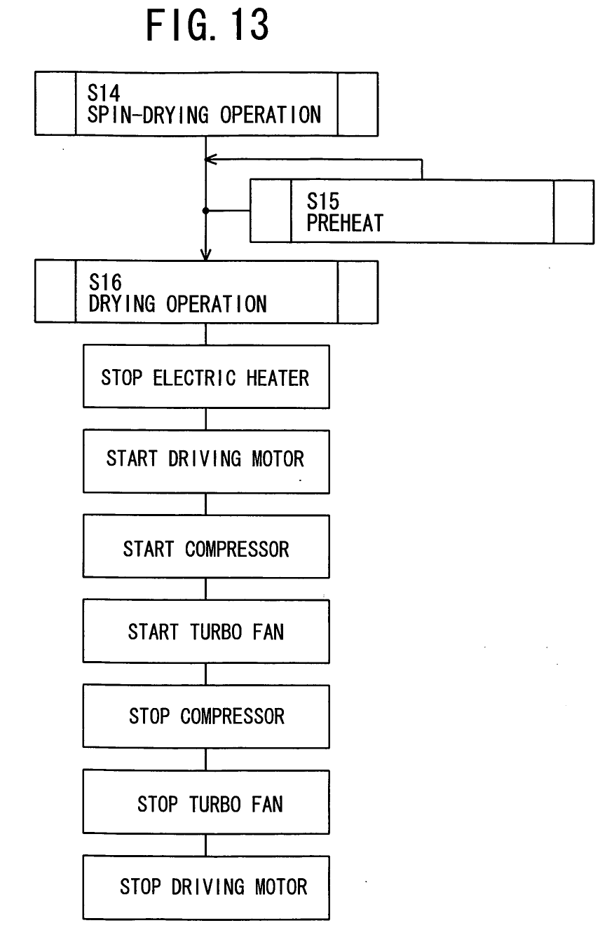

During the spin-drying operation, the control device monitors a temperature of the air measured by a temperature sensor 292 provided in an air circulation path 270 in the vicinity of an entrance of the inner drum 204 (drying chamber 210). When the temperature sensor 292 registers a temperature lower than 30° C., the control device starts a turbo fan 280 and an electric heater 290, thereby starting a preheat operation (S15) (see FIG. 12). In the present embodiment, the turbo fan 280 used has an air blowing capacity of about 2.0 to 2.5 m³/min, and the electric heater 290 used has a rated output of 650 W, so that the temperature of the circulating air can be 30° C. or more by starting the preheat operation (S15) about five minutes before a drying operation. Therefore, if the preheat operation (S15) is started five minutes before the drying operation, it is also possible to have a flow in which the drying operation (S16) is started in such a manner that timing to start a compressor 220 does not depend on the temperature sensor 292. However, since the temperature sensor 292 always monitors the temperature of the air in the inner drum 204 (drying chamber 210) as a safety device to safely open/close an opening/closing door 202 and an opening/closing lid 206, it is easier to avoid a risk of a liquid backflow phenomenon if the timing to start the compressor 220 corresponds to an output from the temperature sensor 292, as shown in FIG. 13. On the other hand, when an outside air temperature exceeds 30° C., for example, in the middle of summer, and the temperature sensor 292 which monitors the temperature at regular intervals (intervals of 20 seconds to one minute in the present embodiment) registers 30° C. or more for a given length of time or more (for three minutes or more in the present embodiment), the preheat operation (S15) is not carried out, and the control device rotates the inner drum 204 by the driving motor to move to the drying operation (S16) after executing the spin-drying process for a predetermined time.

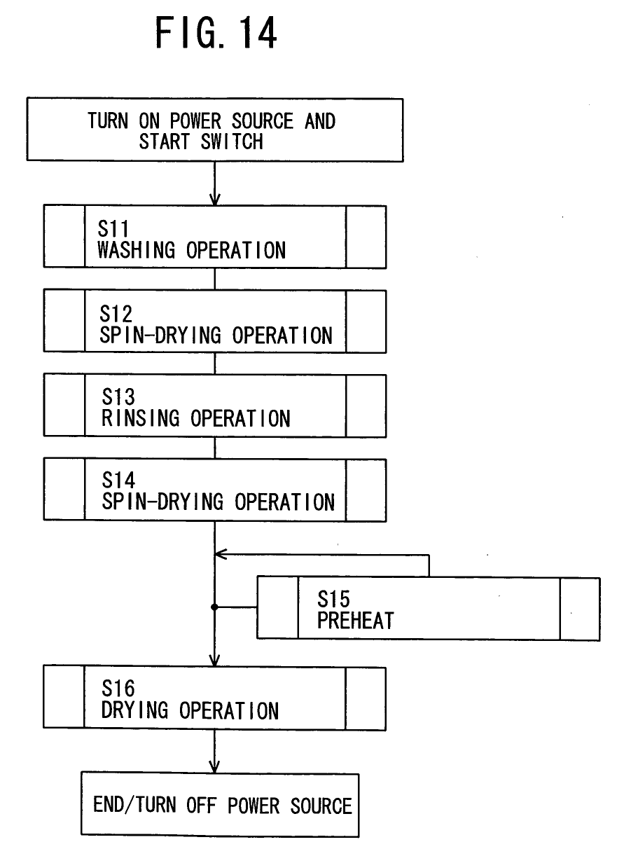

To sum up what has been described above, as shown in FIG. 14, when the power switch and the start switch are operated among the operation switches, the washing/drying apparatus 200 of the present embodiment fully automatically carries out, in accordance with the control device, the washing operation (S11), the spin-drying operation (S12), the rinsing operation (S13), the spin-drying operation (S14) and the drying operation (S16). Further, the temperature sensor 292 monitors the temperature in the washing/drying apparatus 200 so that the control is performed to carry out the preheating (S15) when the liquid backflow phenomenon is likely to occur.

Returning to FIG. 7, in the drying operation (S16), a high-temperature/pressure gas refrigerant discharged from the compressor 220 radiates heat in the gas cooler 230, and thereafter reaches the expansion valve 240. Up to here, the refrigerant is not condensed, and the refrigerant circuit 260 has a supercritical pressure on the high-pressure side. The refrigerant which has reached the expansion valve 240 is decompressed therein and liquefied in this process. Next the refrigerant flows into the evaporator 250 to absorb the heat from its periphery, evaporates, and is drawn in the compressor 220. Such circulation is performed. By the operation of the turbo fan 280, the drying air heated to the high temperature by the heat radiation of the high-temperature/pressure refrigerant in the gas cooler 230 flows out of the inflow side duct member 272 of the air circulation path 270 to flow into the hollow portion 206. The drying air which has flown into the hollow portion 206 flows into the inner drum 204 from the air inflow port 208. The drying air which has flown into the inner drum 204 (drying chamber 210) warms the thing to be dried accommodated in the inner drum 204 (drying chamber 210) to evaporate the moisture, and dries the thing to be dried. The moisture-containing air which has dried the thing to be dried is discharged from an unshown air outlet to the outside of the inner drum 204 via the inner drum 204 (drying chamber 210), passes through the outflow side duct member 274 of the air circulation path 270, is blown in the air passage 276 formed in the case 209 from the inlet 276A, and is introduced into and passed through the evaporator 250 disposed in the passage.

A water content contained in the air from the inner drum 204 (drying chamber 210) (water content evaporated from the thing to be dried) is condensed on the surface of the evaporator 250 in the process of passing through the evaporator 250, and falls as water drops. The water drops which have fallen are discharged into an outer drain ditch or the like from the draining passage via un unshown drain pipe 252. The dried air from which the moisture has been removed by the evaporator 250 is drawn in the turbo fan 280, and passes around the compressor 220 via the communication hole 276D. At this time, the air cooled by the evaporator 250 and drawn in the turbo fan 280 to flow into the gas cooler side case 209B passes around the compressor 220, so that the compressor 220 heated by the operation can be cooled, thereby making it possible to improve durability of the compressor 220 and utilize waste heat of the compressor 220 to dry the thing to be dried.

Furthermore, the air which has cooled the compressor 220 flows into the gas cooler 230 and is thus heated. Then, the air flows out of the outlet 276B of the air passage 276 to enter the inflow side duct member 272, and is sent into the hollow portion 206 of the shaft. The air, in the same manner as described above, flows into the inner drum 204 (drying chamber 210), and removes the water content from the thing to be dried in the inner drum 204 (drying chamber 210) to dry the thing to be dried. Such circulation is repeated. When such a drying operation is performed by the control device for a predetermined time, the thing to be dried in the drying chamber 210 is completely dried. When the air in the air circulation path 270 is heated by the gas cooler 230, and dehumidified by the evaporator 250, the thing to be dried can be efficiently dried. When a refrigerant such as carbon dioxide is used in such a manner as to achieve a supercritical pressure on the high pressure side of the refrigerant circuit, a high heating capacity can be obtained in the gas cooler 230.

### Embodiment 2

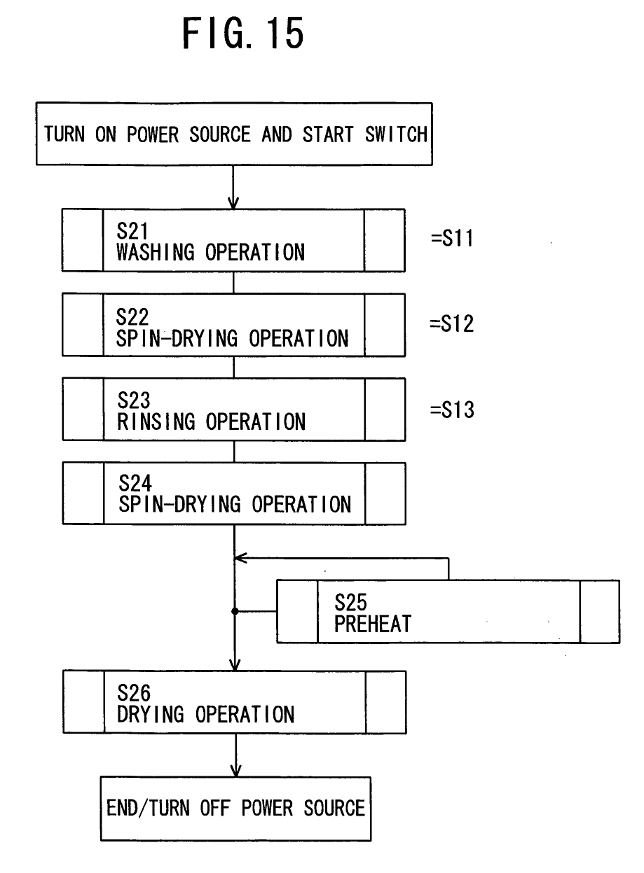

Next, an operation in Embodiment 2 of a washing/drying apparatus 200 will be described with FIGS. 15 to 19.

As shown in FIG. 15, a basic operation is similar to that in Embodiment 1, but operations after a spin-drying operation (S24) are different from those in Embodiment 1. Therefore, a description is omitted for operations ranging from a washing operation (S21) to a rinsing operation (S23) that are similar to those in Embodiment 1, and the operations after the spin-drying operation (S24) will be described.

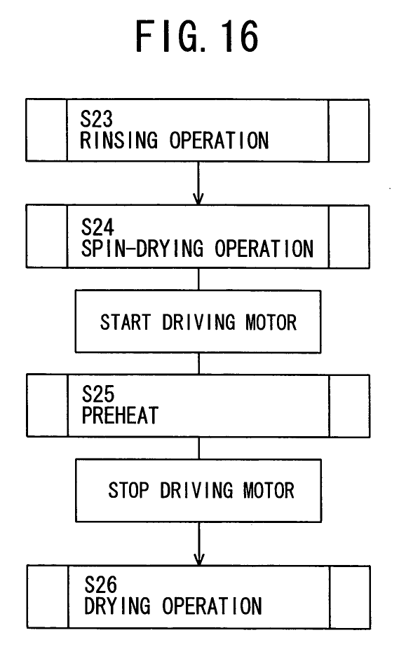

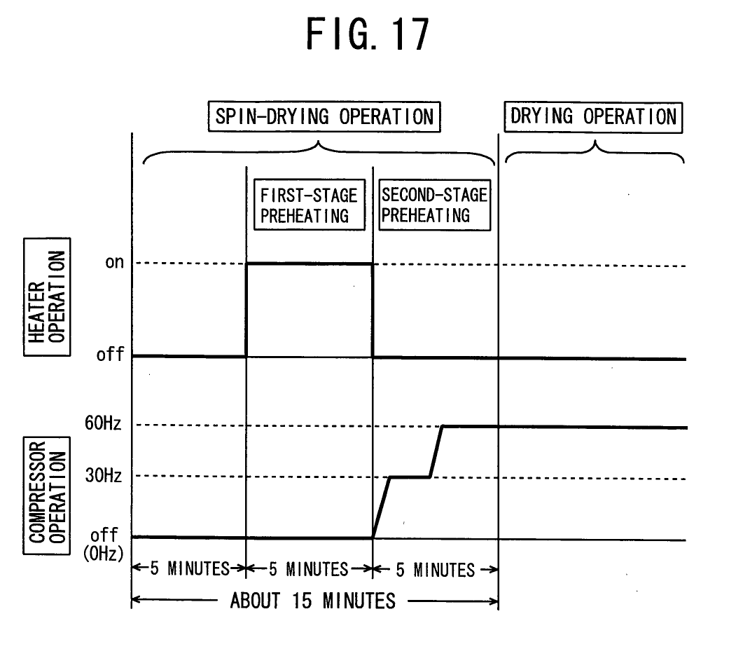

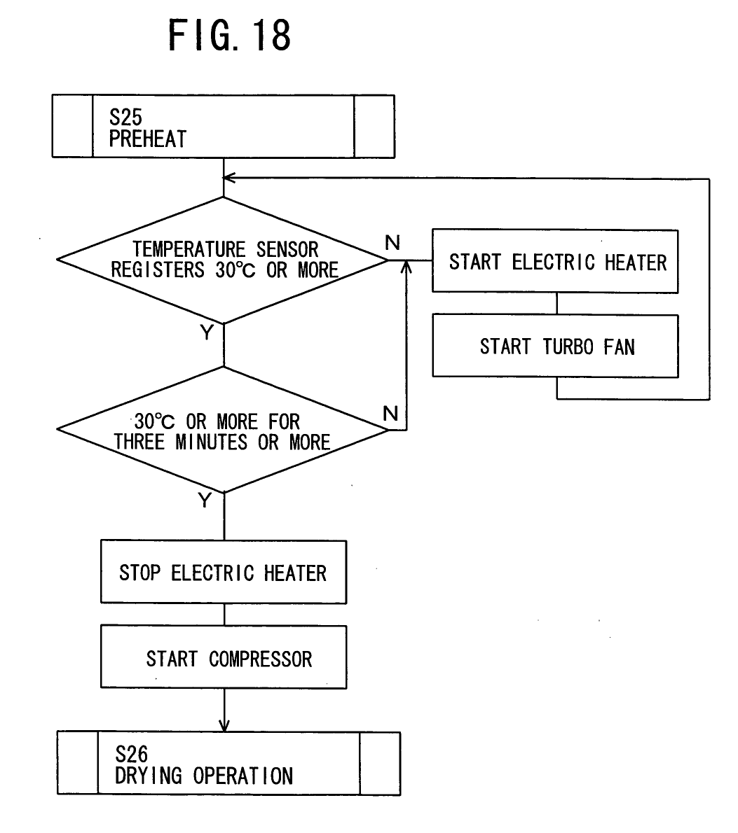

As shown in FIG. 16, a control device starts a preheat operation (S25) during the spin-drying operation (S24). This preheat operation (S25) branches into a first-stage preheating to start an electric heater 290 and a second-stage preheating to start a compressor 220, as shown in FIG. 17. First, when a temperature sensor 292 provided in an air circulation path 270 in the vicinity of an entrance of an inner drum 204 (drying chamber 210) registers a temperature lower than 30° C. or less, a turbo fan 280 and the electric heater 290 are started (first-stage preheating), thereby starting the preheat operation (S25) (see FIG. 18). In the present embodiment, the turbo fan 280 used has an air blowing capacity of about 2.0 to 2.5 m³/min, and the electric heater 290 used has a rated output of 650 W. If a time required for the second-stage preheating is considered, the preheat operation (S25) is started about ten minutes before a drying operation. When a temperature of circulating air has increased to a level at which the temperature sensor 292 registers 30° C. or more for three minutes or more, the electric heater 290 is stopped, and the compressor 220 is started (second-stage preheating).

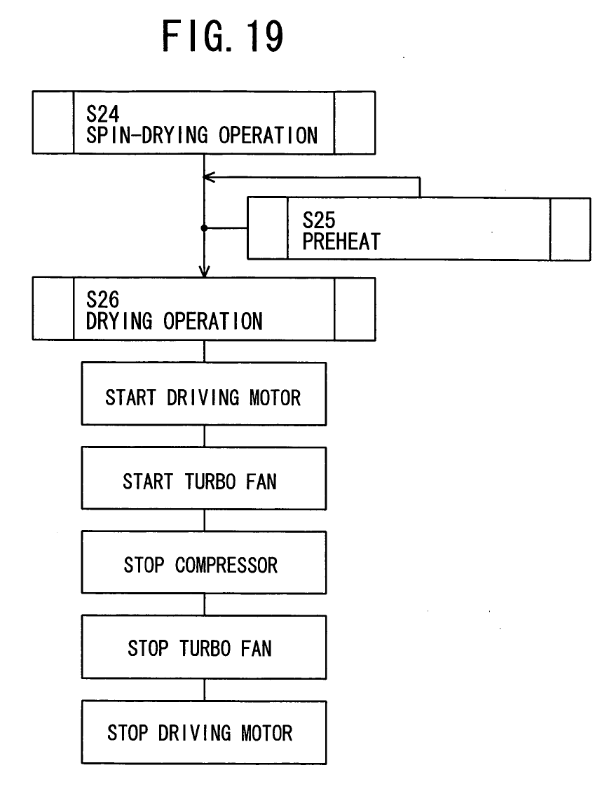

The control device has an inverter which can vary the number of revolutions of the compressor 220. In the present embodiment, the inverter spends a given length of time (20 seconds to one minute in the present embodiment) to increase the number of revolutions of the compressor 220 to 30 Hz, and the compressor 220 is operated at 30 Hz for a given length of time (30 seconds to one and a half minutes in the present embodiment), and then the inverter spends a given length of time (20 seconds to one minute in the present embodiment) to increase the number of revolutions to 60 Hz. Because it generally takes about three minutes for the refrigeration cycle to be in the steady state after the number of revolutions of the compressor 220 has increased to 60 Hz, a total amount of time required for the second-stage preheating is about five minutes, and it is therefore preferable to start the preheat operation (S25) ten minutes before the drying operation. Further, as described in Embodiment 1, when the outside air temperature exceeds 30° C., for example, in the middle of summer, and the temperature sensor 292 which monitors the temperature at regular intervals (intervals of 20 seconds to one minute in the present embodiment) registers 30° C. or more for a given length of time or more (for three minutes or more in the present embodiment), the first-stage preheating is not carried out, and the preheat operation (S25) starts from the second-stage preheating. Then, when the spin-drying process performed in parallel with the preheat operation (S25) is carried out for a predetermined time, the control device rotates the inner drum 204 by the driving motor to move to the drying operation (S26) (see FIG. 19).

The drying apparatus for clothes having the drum-type drying chamber, especially the washing/drying apparatus has been described as a best mode for carrying out the present invention. However, the present invention is not limited thereto, and can also be applied to drying apparatuses for dishes (dish washing/drying apparatuses), dehumidifiers, bathroom drying apparatuses, and the like.

What is claimed is:

1. A drying apparatus comprising: a drying chamber for accommodating a thing to be dried; a refrigerant circuit in which a compressor, a radiator, a decompression device and a heat sink are successively connected to one another in an annular form via a piping; an air circulation path in which air in the drying chamber exchanges heat with the radiator and the heat sink and circulates; and air circulation means provided in the air circulation path for circulating the air,
wherein at least part of the piping from the decompression device to the compressor of the refrigerant circuit is provided within the air circulation path, and the air circulation path is equipped with heating means.

2. The drying apparatus according to claim 1, wherein a refrigerant sealed in the refrigerant circuit is in a liquid state or a gas-liquid mixed state when the compressor is stopped.

3. The drying apparatus according to claim 1 or 2, wherein the refrigerant circulating in the refrigerant circuit is carbon dioxide.

4. A washing/drying apparatus comprising a drying apparatus according to one of claims 1 to 3.

5. An operation method for a drying apparatus which comprises: a drying chamber for accommodating a thing to be dried; a refrigerant circuit in which a compressor, a radiator, a decompression device and a heat sink are successively connected to one another in an annular form via a piping; an air circulation path in which air in the drying chamber exchanges heat with the radiator and the heat sink and circulates; and air circulation means provided in the air circulation path for circulating the air, wherein at least part of the piping from the decompression device to the compressor of the refrigerant circuit is provided within the air circulation path, and the air circulation path is equipped with heating means, the method comprising:
refrigerant state estimation means for estimating a state of the refrigerant sealed in the refrigerant circuit,
wherein the heating means is started before starting the compressor depending on the state of the refrigerant estimated by the refrigerant state estimation means.

6. The operation method for the drying apparatus according to claim 5, wherein the refrigerant state estimation means comprises:
refrigerant temperature detection means for directly or indirectly detecting a temperature of the refrigerant, and
the refrigerant state estimation means estimates the state of the refrigerant from the temperature of the refrigerant detected by the refrigerant temperature detection means.

7. An operation method for a washing/drying apparatus which comprises the steps of washing and drying and which uses a refrigeration cycle in the drying step, the method comprising:
a preheat step which is carried out in parallel with a step immediately before the drying step to heat a refrigerant to a predetermined temperature or more.

8. The operation method for the washing/drying apparatus according to claim 7, wherein the preheat step comprises:
a first preheat step of being supplied with heat from the outside of a refrigerant circuit to bring the refrigerant to the predetermined temperature or more; and
a second preheat step of starting the refrigerant circuit to bring the refrigerant circuit into a steady state.
